(19) United States
(12) Patent Application Publication
(10) Pub. No.: US 2024/0393990 A1
(43) Pub. Date: Nov. 28, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yuta NAKAYAMA, Kanagawa (JP)

(73) Assignee: FUJIFILM Business innovation Corp., Tokyo (JP)

(21) Appl. No.: 18/507,466

(22) Filed: Nov. 13, 2023

(30) Foreign Application Priority Data
May 25, 2023 (JP) 2023-086524

(51) Int. Cl. G06F 3/12

(52) U.S. Cl. CPC G06F 3/1222; G06F 3/1238

(57) ABSTRACT

An information processing system includes one or more processors configured to: accept that a user registers print information serving as a print target and an information processing terminal serving as a transfer destination of the print information; in transferring the registered print information to the registered information processing terminal, perform a first transfer operation that transfers a first portion of the print information to the information processing terminal; and if the information processing terminal serving as the transfer destination is verified as being an information processing terminal of a regular user after the first transfer operation, perform a second transfer operation that transfers a second portion of the print information to the information processing terminal.

### CROSS-REFERENCE TO RELATED APPLICATIONS

This application is based on and claims priority under 35 USC 119 from Japanese Patent Application No. 2023-086524 filed May 25, 2023.

### BACKGROUND

### (i) Technical Field

The present disclosure relates to an information processing system, a non-transitory computer readable medium, and an information processing method.

### (ii) Related Art

Japanese Patent No. 6537390 discloses an image forming apparatus. The image forming apparatus provides a mechanism that receives print data of a page formed to expedite a fast-print operation, starts printing, and transmits the print data without a pull-print application interrupting a communication session with a controller.

The image forming apparatus including a printer is connectable to a print server system that includes a print service providing print data. The image forming apparatus includes a receiving unit and a transmitting unit. The receiving unit receives a uniform resource locator (URL), indicating a storage location of the print data, from the print service that stores the print data in response to the reception of a print instruction from a client terminal and the receiving unit receives the print data in response to the received URL. The transmitting unit transmits the print data to the printer included in the image forming apparatus. When the receiving unit receives part of the print data, the transmitting unit starts communication with the printer and does not disconnect the communication with the printer until the receiving unit has received the remaining print data. The transmitting unit disconnects the communication with the printer in response to the completion of transmission of the print data when the receiving unit has received the remaining print data. The receiving unit receives the URL indicating the storage location of the part of the print data. After receiving the part of the print data in accordance with the received URL, the receiving unit receives a URL indicating the whole remaining print data or the part of the print data.

In a contemplated technique of performing printing using print information, the print information may be registered in a cloud server, the print information may be transferred from the cloud server to an information processing terminal, such as a specified mobile terminal, and the information processing terminal may transmit the print information to an image forming apparatus.

This technique may be beneficial because the image forming apparatus not connected to the cloud server may also perform specific operations, which are typically executed by the cloud server, such as log management, permission operation, or confidential operation.

However, if a wrong information processing terminal is specified as a transfer destination of print information, an unintended user may perform printing using the print information.

### SUMMARY

Aspects of non-limiting embodiments of the present disclosure relate to providing an information processing system, a non-transitory computer readable medium, and an information processing method controlling the use of the print information by an unintended user if a wrong information processing terminal is specified as a predetermined transfer destination of print information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: accept that a user registers print information serving as a print target and an information processing terminal serving as a transfer destination of the print information; in transferring the registered print information to the registered information processing terminal, perform a first transfer operation that transfers a first portion of the print information to the information processing terminal; and if the information processing terminal serving as the transfer destination is verified as being an information processing terminal of a regular user after the first transfer operation, perform a second transfer operation that transfers a second portion of the print information to the information processing terminal.

### BRIEF DESCRIPTION OF THE DRAWINGS

Exemplary embodiments of the present disclosure will be described in detail based on the following figures, wherein:

FIG. 1 illustrates a configuration example of an information processing system of a first exemplary embodiment of the disclosure;

FIG. 2 illustrates an electrical configuration example of a cloud server of the first exemplary embodiment of the disclosure;

FIG. 3 is a block diagram illustrating an electrical configuration example of a client computer of the first exemplary embodiment of the disclosure;

FIG. 4 is a block diagram illustrating an electrical configuration example of an information processing terminal of the first exemplary embodiment of the disclosure;

FIG. 5 schematically illustrates a process performed by the information processing system of the first exemplary embodiment of the disclosure;

FIG. 6 illustrates a process flow from registering the information processing terminal to a print management system to starting using the information processing terminal in accordance with the first exemplary embodiment of the disclosure;

FIG. 7 illustrates an example of a registration screen used when the information processing terminal of the first exemplary embodiment of the disclosure is registered on the print management system;

FIG. 8 illustrates the registration of a print job on the print management system of the first exemplary embodiment of the disclosure;

FIG. 9 illustrates an example of a print setting screen used when the information processing terminal at a spool destination is set on a print tool of the client computer of the first exemplary embodiment of the disclosure;

FIG. 10 illustrates an example of a process flow that is performed until the print job registered on the print management system of the first exemplary embodiment of the disclosure is spooled on the information processing terminal;

FIG. 11 illustrates a screen example that is displayed during and after the spooling on the information processing terminal of the first exemplary embodiment of the disclosure;

FIG. 12 illustrates a process flow until the print job spooled on the information processing terminal of the first exemplary embodiment of the disclosure is transmitted to an image forming apparatus;

FIG. 13 illustrates an example of a print job list screen of the first exemplary embodiment of the disclosure;

FIG. 14 illustrates how a problem of transmitting print information to a wrong user occurs;

FIG. 15 illustrates a transfer division process of the information processing system of the first exemplary embodiment of the disclosure;

FIG. 16 is a functional block diagram illustrating an example of the information processing system according to the first exemplary embodiment of the disclosure;

FIG. 17 illustrates a structure example of a print setting information database of the first exemplary embodiment of the disclosure;

FIG. 18 is a flowchart illustrating an example of a server-side information processing process according to the first exemplary embodiment of the disclosure;

FIG. 19 is a flowchart illustrating an example of a terminal-side information processing process according to the first exemplary embodiment of the disclosure;

FIG. 20 illustrates an example of a password entry screen according to the first exemplary embodiment of the disclosure;

FIG. 21 is a functional block diagram illustrating of an information processing system according to a second exemplary embodiment of the disclosure; and

FIG. 22 is a flowchart illustrating an example of a server-side information processing process according to the second exemplary embodiment of the disclosure.

### DETAILED DESCRIPTION

Exemplary embodiments of the disclosure are described in detail with reference to the drawings.

An information processing system 1 of the exemplary embodiments of the disclosure includes a cloud server, image forming apparatus, client computer, and information processing apparatus interconnected to each other via communication networks, including a variety of type of networks.

### First Exemplary Embodiment

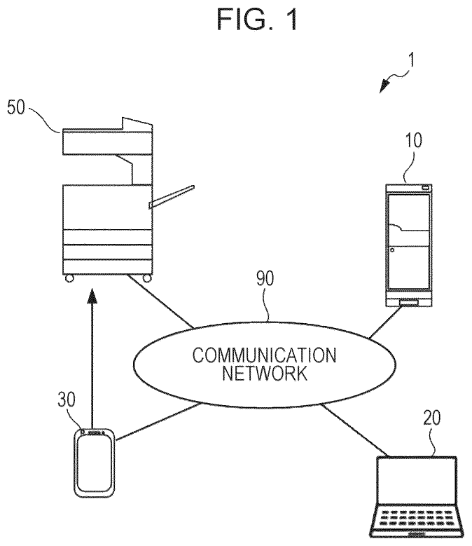

The information processing system 1 of a first exemplary embodiment is described below with reference to FIG. 1. FIG. 1 illustrates a configuration example of the information processing system 1 of the first exemplary embodiment.

Referring to FIG. 1, the information processing system 1 of the exemplary embodiment includes a cloud server 10, client computer 20, information processing terminal 30, and image forming apparatus 50. The cloud server 10, client computer 20, and image forming apparatus 50 are interconnected to each other via a communication network 90, such as a local-area network (LAN), wide-area network (WAN), Internet, and/or intranet. The cloud server 10, client computer 20, information processing terminal 30, and image forming apparatus 50 exchange a variety of data with each other via the communication network 90. According to the exemplary embodiment, the image forming apparatus 50 forms an image in response to a print instruction when the client computer 20 or information processing terminal 30 provides the print instruction to the image forming apparatus 50 via the cloud server 10.

For convenience of explanation, FIG. 1 illustrates a single cloud server 10, single client computer 20, single information processing terminal 30, and single image forming apparatus 50. Alternatively, multiple apparatuses of at least one of these types may be employed. The information processing system 1 of the exemplary embodiment may not only provide a print instruction from the information processing terminal 30 via the communication network 90 and but also provide the print instruction via near field communication, such as Wi-Fi (registered trademark) or Bluetooth (registered trademark).

An example of the cloud server 10 and the client computer 20 may be an information processing apparatus, such as a personal computer and a server computer. An example of the information processing terminal 30 may be a mobile phone, such as a smart phone, or a variety of mobile terminals, such as a personal digital assistant (PDA) or a notebook computer.

According to the exemplar embodiment, the image forming apparatus 50 may be a digital multi-function apparatus having an image printing function, image reading function, and image transmission function. The image forming apparatus 50 is not limited to such an apparatus. For example, the image forming apparatus 50 may be an image forming apparatus having only the image printing function, or an image forming apparatus having the image printing function and the image reading function.

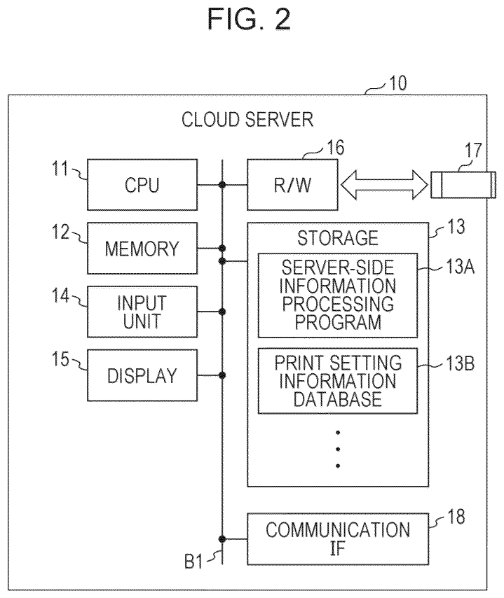

The configuration of the cloud server 10 of the exemplary embodiment is described with reference to FIG. 2. FIG. 2 illustrates an electrical configuration example of the cloud server 10 of the exemplary embodiment.

Referring to FIG. 2, the cloud server 10 of the exemplary embodiment includes a central processing unit (CPU) 11, serving as a processor, memory 12 serving as a temporary memory region, non-volatile storage 13, input unit 14, such as a keyboard and a mouse, display 15, such as a liquid-crystal display, medium reader/writer (R/W) 16, and communication IF (interface) 18. The CPU 11, memory 12, storage 13, input unit 14, display 15, medium reader/writer 16, and communication IF 18 are interconnected to each other via a bus B1. The medium reader/writer 16 reads information written on a recording medium 17 and writes information onto the recording medium 17.

The storage 13 of the exemplary embodiment may be implemented by a hard-disk drive (HDD), solid-state drive (SSD), or flash memory. The storage 13 as a recording medium stores a server-side information processing program 13A. The server-side information processing program 13A is stored (installed) onto the storage 13 when the recording medium 17 having the server-side information processing program 13A recorded thereon is connected to the medium reader/writer 16 and the medium reader/writer 16 reads the server-side information processing program 13A from the recording medium 17. The CPU 11 reads the server-side information processing program 13A from the storage 13 as appropriate and loads the server-side information processing program 13A on the memory 12 and then executes each process of the server-side information processing program 13A.

The storage 13 also stores a print setting information database 13B. The print setting information database 13B is described below in greater detail.

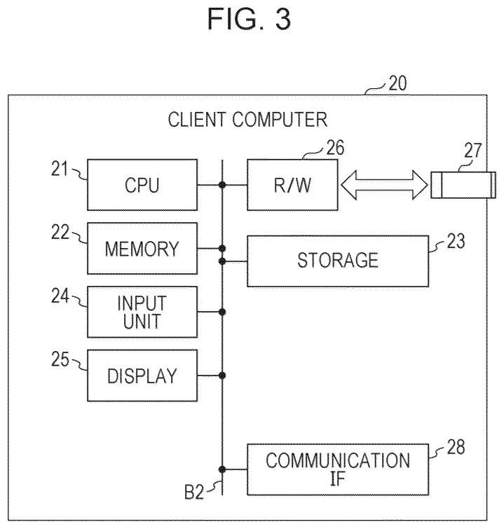

The configuration of the client computer 20 of the exemplary embodiment is described with reference to FIG. 3. FIG. 3 is a block diagram illustrating an electrical configuration example of the client computer 20 of the exemplary embodiment.

Referring to FIG. 3, the client computer 20 of the exemplary embodiment includes a CPU 21, serving as a processor, memory 22 serving as a temporary memory region, non-volatile storage 23, input unit 24, such as a keyboard and a mouse, display 25, such as a liquid-crystal display, medium reader/writer 26, and communication IF 28. The CPU 21, memory 22, storage 23, input unit 24, display 25, medium reader/writer 26, and communication IF 28 are interconnected to each other via a bus B2. The medium reader/writer 26 reads information written on a recording medium 27 and writes information onto the recording medium 27. The storage 23 of the exemplary embodiment may be implemented by an HDD, SSD, or flash memory.

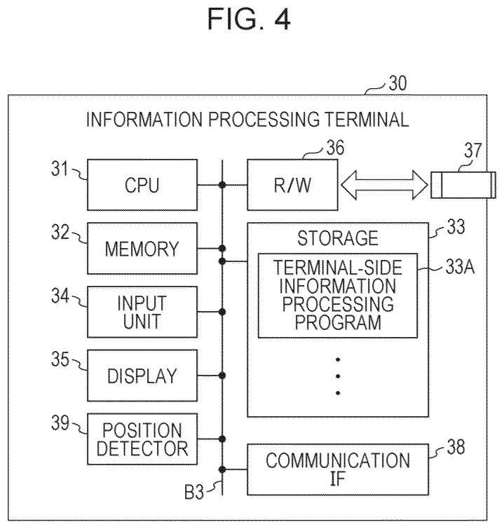

The configuration of the information processing terminal 30 of the exemplary embodiment is described with reference to FIG. 4. FIG. 4 is a block diagram illustrating an electrical configuration example of the information processing terminal 30 of the exemplary embodiment.

Referring to FIG. 4, the information processing terminal 30 of the exemplary embodiment includes a CPU 31, serving as a processor, memory 32 serving as a temporary memory region, non-volatile storage 33, input unit 34, such as a keyboard and a mouse, display 35, such as a liquid-crystal display, medium reader/writer 36, communication IF 38, and position detector 39. The CPU 31, memory 32, storage 33, input unit 34, display 35, medium reader/writer 36, communication IF 38, and position detector 39 are interconnected to each other via a bus B3. The medium reader/writer 36 reads information written on a recording medium 37 and writes information onto the recording medium 37.

The storage 33 of the exemplary embodiment may be implemented by a HDD, SSD, or flash memory. The storage 33 as a recording medium stores a terminal-side information processing program 33A. The terminal-side information processing program 33A is stored onto the storage 23 when the recording medium 37 having the terminal-side information processing program 33A recorded thereon is connected to the medium reader/writer 36 and the medium reader/writer 36 reads the terminal-side information processing program 33A from the recording medium 37. The CPU 31 reads the terminal-side information processing program 33A from the storage 33 as appropriate and loads the terminal-side information processing program 33A on the memory 32 and then executes each process of the terminal-side information processing program 33A.

The position detector 39 of the exemplary embodiment detects the position of the information processing terminal 30 in a horizontal direction using the global positioning system (GPS) and the position of the information processing terminal 30 in a height direction using Pinnacle/Metropolitan Beacon System (MBS). The position detector 39 is not limited to this system. For example, a device able to detect a position in the height direction using GPS may be used to detect a position of the information processing terminal 30 in three-dimensional directions using GPS alone and may thus be applied to the position detector 39.

In the information processing system 1 of the exemplary embodiment, the cloud server 10 provides, as a cloud service, a print management system including the image forming apparatus 50 that performs printing by performing specific operations on a print job. The specific operations include a log management operation that manages a log of the print job, a permission operation that permits the print job to be performed, and a confidential operation that masks a confidential portion of the print job. In the print management system, the cloud server 10 receives the print job from the client computer 20, performs the permission operation on the received print job, and then transmits the permitted print job to the image forming apparatus 50. In this way, the image forming apparatus 50 performs printing only in accordance with a permitted print job. The term “print job” refers to a process unit of printing operation executed in response to one instruction from an operator.

If the image forming apparatus 50 not connected to the information processing system 1 or not permitted to be connected to the information processing system 1 attempts to perform printing, a specific operation available on the information processing system 1 may not be usable.

The information processing system 1 of the exemplary embodiment receives a print job including print information and serving as a print target, performs a specific operation on the print information included in the received print job, and transmits the print job including the print information having undergone the specific operation to the information processing terminal 30 instead of directly transmitting the print job to the image forming apparatus 50.

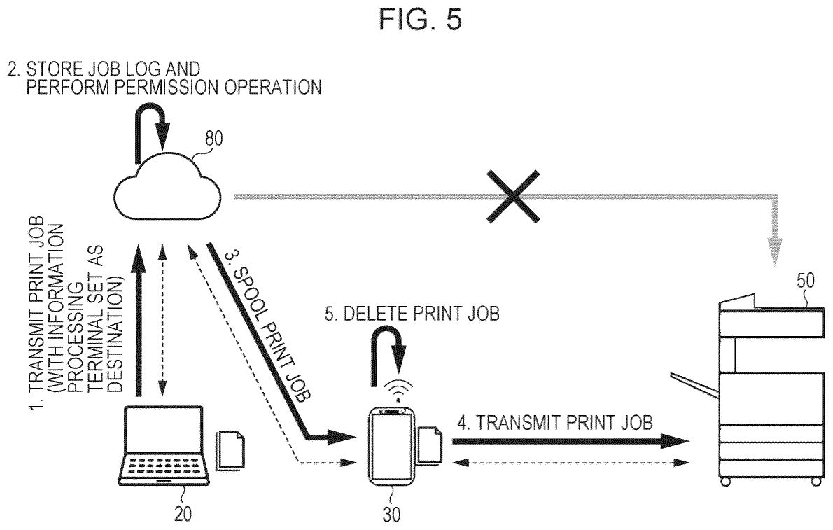

Specifically, referring to FIG. 5, the client computer 20 or the information processing terminal 30 transmits the print job to the print management system 80 over a cloud with the destination of the print job set to the information processing terminal 30. FIG. 5 schematically illustrates the process performed by the information processing system 1 of the exemplary embodiment.

The print management system 80 receives the print job and performs the specific operation including storing a job log managing a log and performing a permission operation on printing. For example, the permission operation may be performed by requesting permission from a pre-registered client computer 20 to print the print job and by receiving permission results.

The print management system 80 transmits the print job having undergone the specific operation to an information processing terminal 30 serving as a destination specified by the client computer 20 or information processing terminal 30 and then spools the print job on the information processing terminal 30 serving as the destination. The term “spool” refers to “temporarily storing the print information at a different location” rather than “directly transmitting the print information to the image forming apparatus 50.”

When the information processing terminal 30 transmits the spooled print job to the image forming apparatus 50 via the near field communication, the image forming apparatus 50 is caused to perform printing in accordance with the print job having undergone the specific operation. In this way, even the image forming apparatus 50 not connected to the information processing system 1 or not permitted to be connected to the information processing system 1 may perform the printing using the specific operation available on the information processing system 1. According to the exemplary embodiment, the information processing terminal 30 transmits the print job to the image forming apparatus 50 via the near field communication. However, the communication is not limited to the near field communication. For example, the print job may be transmitted via the communication network 90 or directly transmitted to the image forming apparatus 50 via a wired communication link.

The basic method of performing the printing on the image forming apparatus 50 by spooling the print job on the information processing terminal 30 is specifically described.

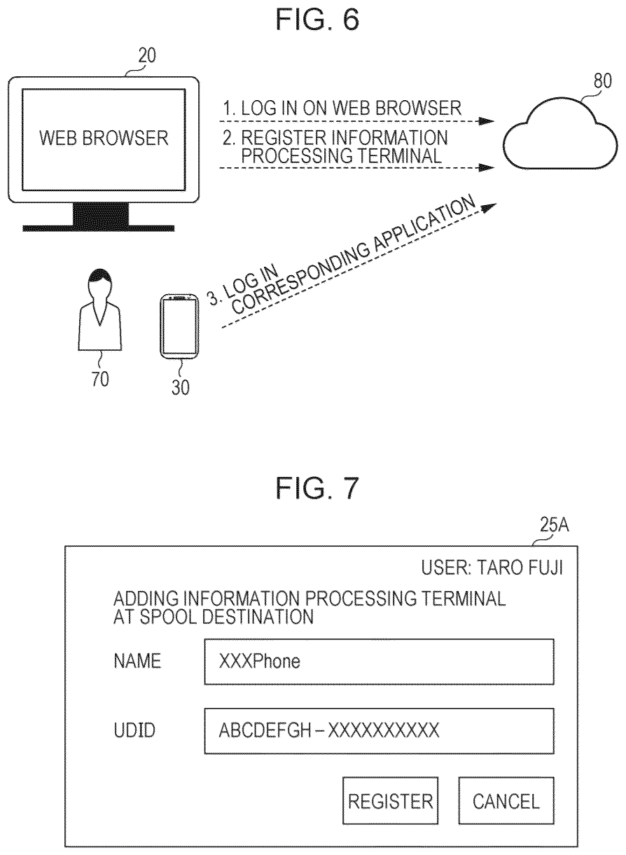

A process flow from registering the information processing terminal 30 to the print management system 80 to starting using the print management system 80 is described below. FIG. 6 illustrates the process flow from registering the information processing terminal 30 to the print management system 80 to starting using the print management system 80.

In the information processing system 1 of the exemplary embodiment, a user 70 logs in on the print management system 80 through a web browser via the client computer 20 or the information processing terminal 30 used by the user 70 and registers the information processing terminal 30 used by the user 70.

Information used to register the information processing terminal 30 may include information uniquely identifying the information processing terminal 30, such as unique device identifier (UDID), serial number, international mobile equipment identity (IMEI) number, or media access control (MAC) address.

The user 70 installs an application supporting the information processing terminal 30 (hereinafter referred to as “support application”) and then logs in on the print management system 80. This leads to the state in which the print job is ready to be spooled on the registered information processing terminal 30.

When the information processing terminal 30 is registered, a registration screen 25A illustrated in FIG. 7 is displayed and the registration of the information processing terminal 30 may thus be accepted. FIG. 7 illustrates an example of the registration screen 25A used to register the information processing terminal 30 on the print management system 80.

In the example of the registration screen 25A in FIG. 7, “XXXPhone” is entered as the name of the information processing terminal 30 and “ABCDEFGH-XXXXXXXXXX” is entered as UDID. The information processing terminal 30 is registered on the print management system 80 by selecting a register button in FIG. 7. Selecting a cancel button cancels the registration of the information processing terminal 30.

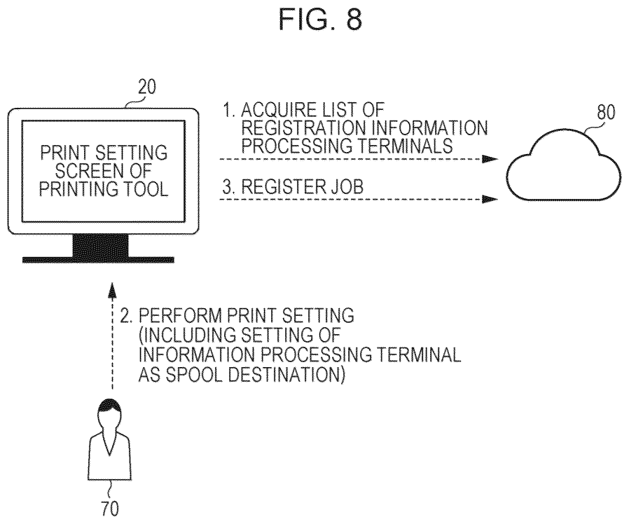

An example of how the print job is registered on the print management system 80 is described below. FIG. 8 illustrates the registration of the print job on the print management system 80.

The information processing system 1 of the exemplary embodiment registers the print job using a print tool including a web user interface (UI) or a printer driver supporting cloud printing.

Specifically, when a print setting screen of the print tool, such as the printer driver or the web UI, a list of the information processing terminals 30 serving as a spool destination corresponding to the user 70 having logged on the print management system 80 is downloaded and thus obtained from the print management system 80.

The user 70 registers the print job (for “job registration”) by specifying an information processing terminal 30 as the spool destination from the list of the information processing terminals 30. In specifying the information processing terminal 30 as the spool destination, all the information processing terminals 30 of the user 70 may be selected or any information processing terminal 30 specified by the user 70 may be selected.

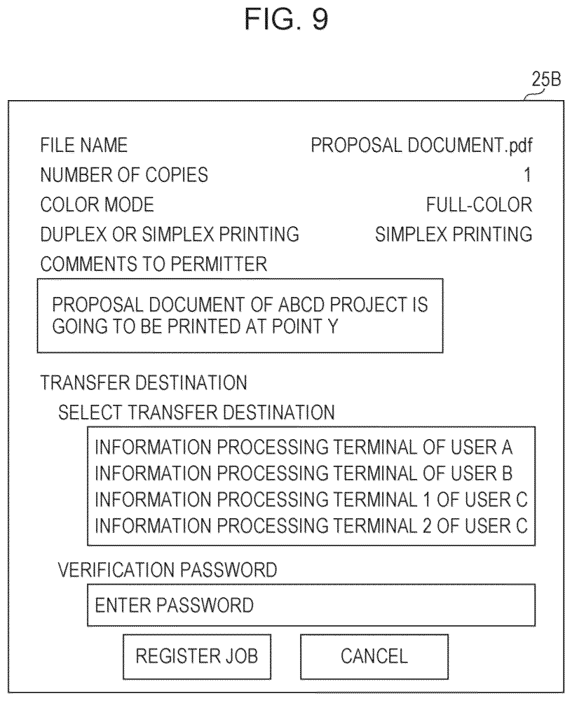

FIG. 9 illustrates an example of a print setting screen 25B used when the information processing terminal 30 at a spool destination is set on a print tool of the client computer 20. The print setting screen 25B in FIG. 9 illustrates a file name “Proposal document.pdf,” number of copies “1,” color mode “Full color,” and duplex or simplex printing “simplex.” The print setting screen 25B in FIG. 9 also illustrates permitter's comments “Proposal document ABCD Project is going to be printed at Point Y.” In the print setting screen 25B in FIG. 9, “Information processing terminal of user A,” “Information processing terminal of user B,” and other information terminals are selected as the information processing terminals 30 at the spool destinations.

In the information processing system 1 of the exemplary embodiment as described below, part of the print information is transmitted first to the information processing terminal 30 before transmitting the whole print information and then transmits the remaining print information only if a preset authorized password (hereinafter referred to as a “verification password”) is entered.

As illustrated in FIG. 9, the verification password is entered on the print setting screen 25B of the exemplary embodiment. Selecting the register job button in FIG. 9 registers the print job on the print management system 80. Selecting the cancel button cancels the registration of the print job.

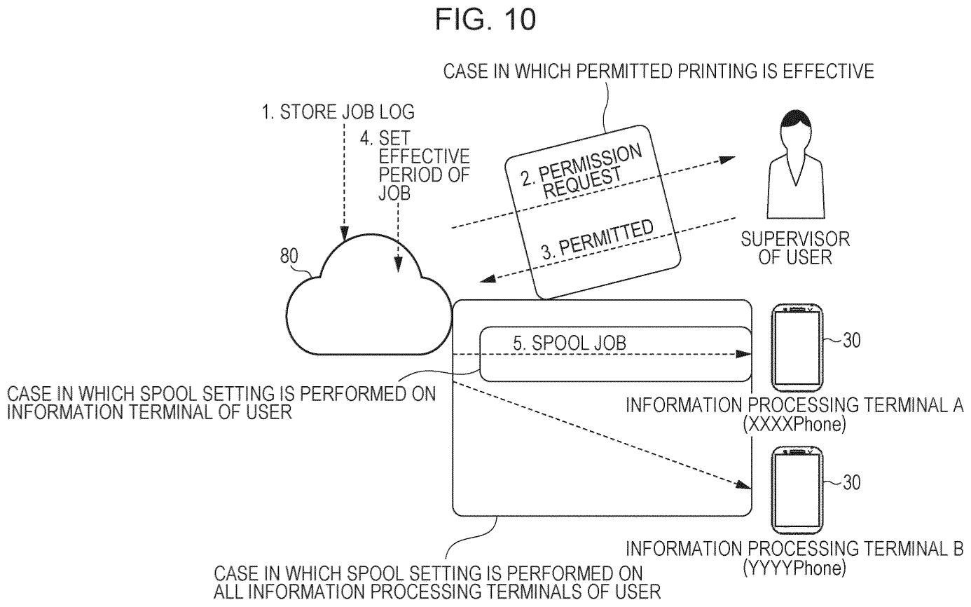

A process flow that is performed until the print job registered on the print management system 80 is spooled on the information processing terminal 30 is described below. FIG. 10 illustrates an example of the process flow that is performed until the print job registered on the print management system 80 is spooled on the information processing terminal 30. In the following discussion, the specific operations include the log management operation, permission operation, and effective period setting operation that sets the effective period of the print job.

When the print job is registered on the print management system 80, the print management system 80 over the cloud stores a job log, performs print permission by making a permission request, sets the effective period of the print job, and then spools the print job on the information processing terminal 30. As illustrated more in detail in FIG. 10, the print management system 80 stores the job log and performs the permission operation if the permitted printing is effective. Specifically, the print management system 80 transmits the permission request to the client computer 20 used by the supervisor of the user 70 and then receives the permission results responsive to the print job. The print job is permitted after the permission results are received, the print management system 80 sets the effective period of the print job. A predetermined period may be set as the effective period. For example, a period for the permitted printing or a default period may be beforehand set as the predetermined period and then the effective period may be determined from the predetermined period.

After all the operations are complete, the print job is spooled on the information processing terminal 30 as the spool destination specified during the job registration. FIG. 10 illustrates the case of the transmission to the information processing terminal 30 specified by the user 70 where the print job is spooled on only the information processing terminal A (XXXXPhone) and the case of the transmission to all the information processing terminals 30 of the user 70 where the print job is spooled on the information processing terminal A (XXXXPhone) and information processing terminal B (YYYYPhone).

The structure of the spooled print job includes “print information” and “attribute information of the print information” and these pieces of information are collectively referred as the print job. The attribute information includes print setting information managed separately from the print information and information including the effective period and thumbnail of the print job.

The spooling of the print job may be performed in the way in which the cloud transmits the print job to the information processing terminal 30 in a push method or in the way in which the information processing terminal 30 receives the print job at any timing of the user 70 in a pull method.

In the case where the information processing terminal 30 performs the printing at another point or a destination, an output destination may not necessarily be the image forming apparatus 50 of the user's own company. For this reason, the print job is converted into a predetermined common format and then spooled on the information processing terminal 30 such that the printing is performed regardless of the type of the image forming apparatus 50. The common format may be portable document format (PDF) or Mopria. The print job is thus converted to the format common to a variety of companies and then spooled on the information processing terminal 30.

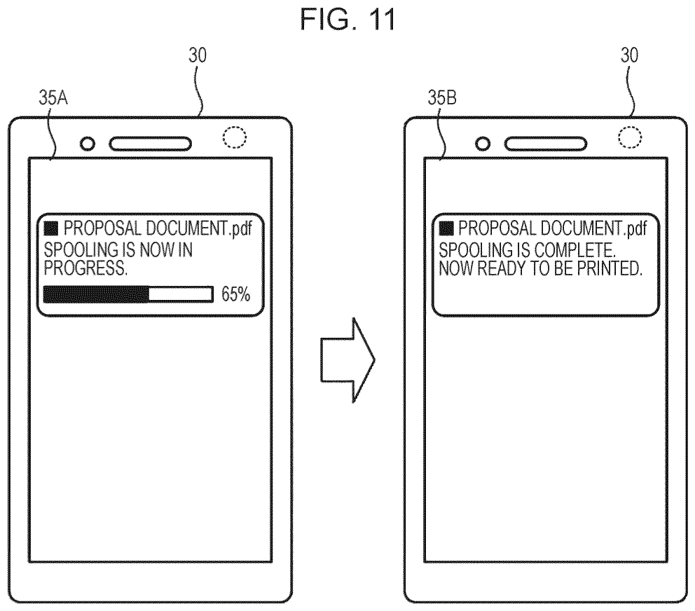

FIG. 11 illustrates a screen example of the progress screen 35A that is displayed in the middle of the spooling of the print job on the information processing terminal 30 and a screen example of the spool completion screen 35B that is displayed after the completion of the spooling.

When the print job is spooled on the information processing terminal 30, a progress status with the spooling in progress is displayed on the progress screen 35A in FIG. 11. The progress screen 35A in FIG. 11 indicates that the print job of “Proposal document.pdf” is being spooled with 65% of the spooling completed. When the spooling is complete, the spool completion screen 35B is displayed. The spool completion screen 35B in FIG. 11 indicates that the spooling of the print job of “Proposal document.pdf” is complete and the printing is ready to be started.

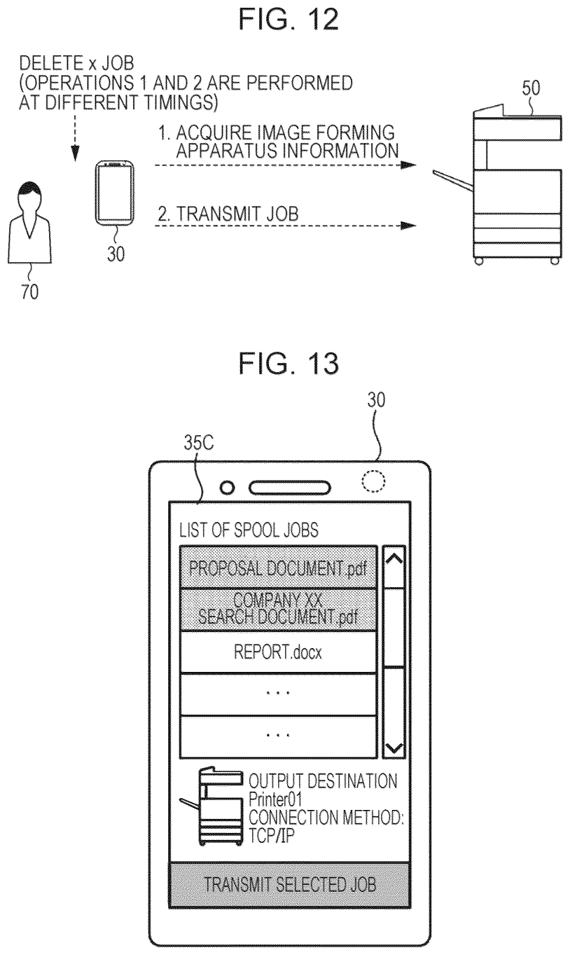

A process flow until the print job spooled on the information processing terminal 30 is transmitted to the image forming apparatus 50 is described below. FIG. 12 illustrates the process flow until the print job spooled on the information processing terminal 30 is transmitted to the image forming apparatus 50.

The support application of the information processing terminal 30 is started up. As illustrated in FIG. 12, an Internet protocol (IP) address of the image forming apparatus 50 serving as a connection destination is acquired and set to transmit the print job to the image forming apparatus 50.

Information used to connect to the image forming apparatus 50 may be manually set by the user 70, or may be set by near field communication (NFC) touching on the image forming apparatus 50 or by reading quick response (QR) code.

The print job may be transmitted in response to an operation performed by the user 70. Referring to FIG. 13, in accordance with the support applications of the information processing terminal 30, the user 70 transmits the print job to the image forming apparatus 50 by displaying a print job list screen 35C listing spooled print jobs, selecting a print job to be printed, and then selecting a transmit button. FIG. 13 illustrates an example of the print job list screen 35C displaying the spooled print jobs. Referring to FIG. 13, two print jobs, “Proposal document.pdf” and “Company XX search document,” are selected and other documents including “Report.docx” remain unselected.

The support application of the information processing terminal 30 periodically checks the effective period of each spooled print job in accordance with the attribute information and deletes a print job if the effective period of the print job has expired regardless of whether the print job has been transmitted to the image forming apparatus 50.

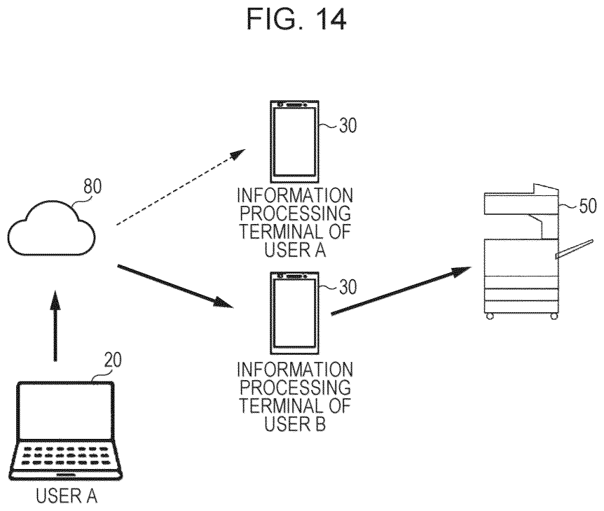

The basic process flow of the information processing system 1 of the exemplary embodiment has been described. If the print management system 80 is used by multiple users 70 having a shared account and a wrong spool destination is specified, the print job may possibly be sent to an information processing terminal 30 or a user account of an unintended user 70. This may lead to the printing of the print job by a wrong user 70. FIG. 14 illustrates how a problem of transmitting the print information to the wrong user 70 occurs.

If the user A wants to use the image forming apparatus 50 for printing as illustrated in FIG. 14, the user A may register the print job for the printing on the print management system 80 and causes the information processing terminal 30 of the user A to spool the print job.

Since the shared account is used in the environment of the user A, the information processing terminal 30 of another user 70 is also registered on the print management system 80. If the information processing terminal 30 of the user B is wrongly selected as the information processing terminal 30 as a spool target, the print job is spooled on the information processing terminal 30 of the user B against the user A's intention. This leads to an environment where another user 70 is permitted to make printing.

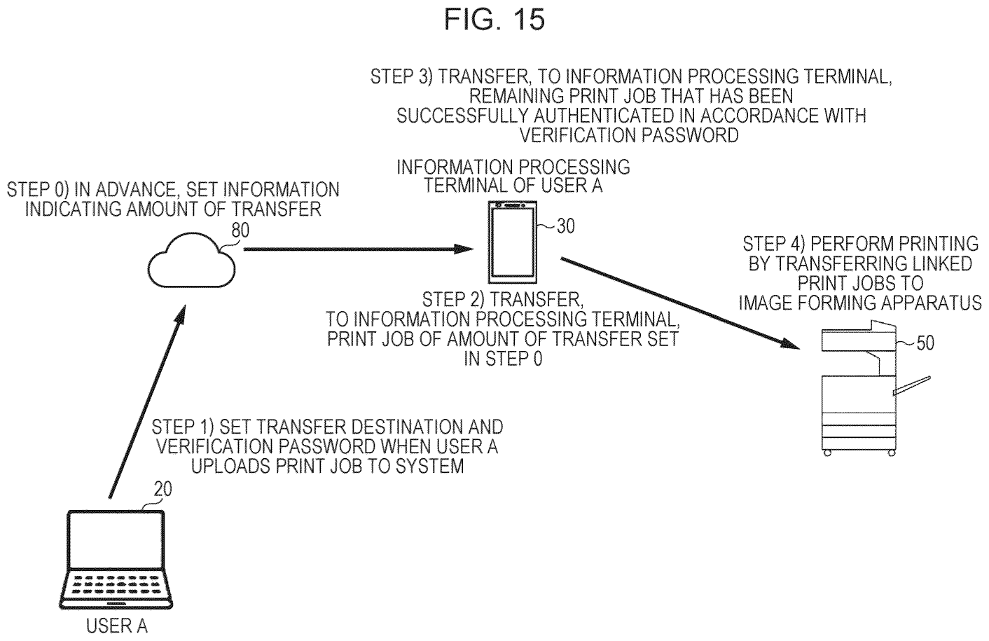

When the print job is transferred (spooled) from the print management system 80 (the cloud server 10) to the information processing terminal 30 in the information processing system 1 of the exemplary embodiment, the transferring is performed in divisions (two divisions in the exemplary embodiment) in a transfer division process. FIG. 15 illustrates the transfer division process of the information processing system 1 of the exemplary embodiment.

In the information processing system of the exemplary embodiment 1 in FIG. 15, an amount of transfer of the print job in a first division is beforehand registered by the administrator of the print management system 80 or the user 70 (step 0). According to the exemplary embodiment, the amount of transfer is a percentage amount of the overall amount of the print job, for example, 10% or 20%. The disclosure is not limited to this setting. For example, the amount of transfer may be fixed to an amount (for example, 10 bytes) less than a minimum amount of data (for example, 100 bytes) of the print job considered.

When the user A uploads the print job to the print management system 80 in this condition, the user A selectively specifies a transfer destination from pre-registered information processing terminals 30. In this case, the user A sets the verification password (step 1).

At a specific timing (at the timing of the end of the specific operation described above in the exemplary embodiment), the print management system 80 transfers the print job of the amount of transfer set in step 0 to the information processing terminal 30 of the user A (step 2).

When the timing of printing of the portion of the print job has come, the information processing terminal 30 requests the user 70 to enter the verification password. In response, the user A enters the verification password registered in step 0. If the verification password has been successfully verified, the print management system 80 transfers the remaining print job to the information processing terminal 30 (step 3).

The information processing terminal 30 reproduces the final print job, namely, the print job registered on the print management system 80 by combining the print jobs transferred in the two divisions from the print management system 80. The information processing terminal 30 causes the image forming apparatus 50 to perform printing in response to the print job by transferring the reproduced print job to the image forming apparatus 50 (step 4).

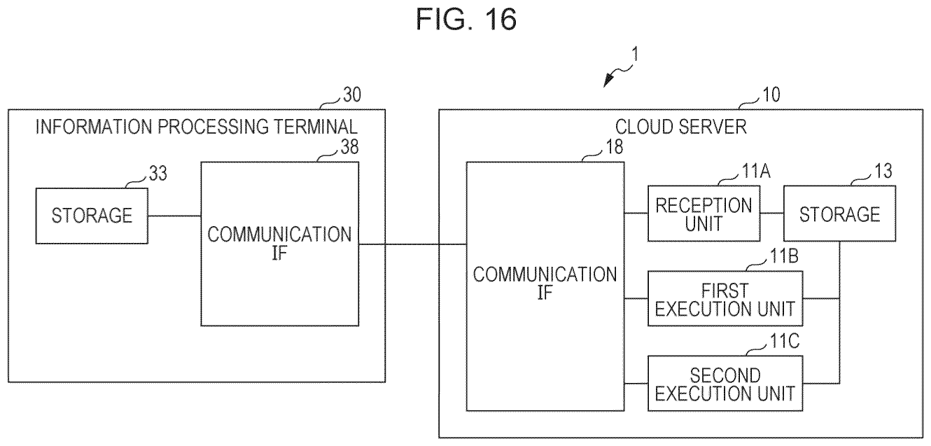

The functional configuration of the information processing system 1 of the first exemplary embodiment with the print job being spooled in the two divisions is described with reference to FIG. 16. FIG. 16 is a functional block diagram illustrating an example of the information processing system 1 according to the exemplary embodiment.

The cloud server 10 of the exemplary embodiment includes a reception unit 11A, first execution unit 11B, and second execution unit 11C as illustrated in FIG. 16. The CPU 11 in the cloud server 10 operates as the reception unit 11A, first execution unit 11B, and second execution unit 11C by executing the server-side information processing program 13A.

The reception unit 11A of the exemplary embodiment accepts the registration of the print information and the information processing terminal 30 serving as the transfer destination of the print information. To transfer the registered print information to the registered information processing terminal 30, the first execution unit 11B performs a first transfer operation to transfer a portion of the print information to the information processing terminal 30. If the information processing terminal 30 serving as a transfer destination is verified as being the information processing terminal 30 of a regular user 70 after the first transfer operation, the second execution unit 11C performs a second transfer operation to transfer another portion of the print information to the information processing terminal 30.

In the information processing system 1 of the exemplary embodiment, the portion of the print information is information having a predetermined percentage of the print information and the reception unit 11A continues to receive the percentage of the print information.

In the information processing system 1 of the exemplary embodiment, the verification is performed using the verification password registered by the user 70. The disclosure is not limited to this setting. For example, the administrator of the print management system 80 may register the verification password.

The memory capacity of the information processing terminal 30 is limited and the size of the print job to be spooled may consume greatly the memory capacity. When the transfer division process is performed, the data size of the portion of the print job to be transferred first may be as smaller as possible. On the other hand, the size of the remaining print job to be transferred during the actual printing becomes larger and a transfer time to transfer the remaining print job during the actual printing becomes longer. In this way, a trade-off relationship thus arises between the consumption of the memory capacity of the information processing terminal 30 and the transfer time of the print job.

The information processing system 1 of the exemplary embodiment has a priority target setting function that determines which of the memory capacity of the information processing terminal 30 and the transfer time of the print job is to be prioritized.

In the information processing system 1 of the exemplary embodiment, capacity priority (the memory capacity of the information processing terminal 30 is prioritized) relatively reduces the initial amount of transfer of the print job in comparison with time priority (the transfer time of the print job is prioritized). Specifically, if the capacity priority is set, the initial amount of transfer of the print job is set to a value within a range from 10% to 50% of the print job (10% of the print job in the exemplary embodiment). If the time priority is set, the initial amount of transfer of the print job is set to a value within a range from 50% or higher and lower than 90% of the print job (90% of the print job in the exemplary embodiment).

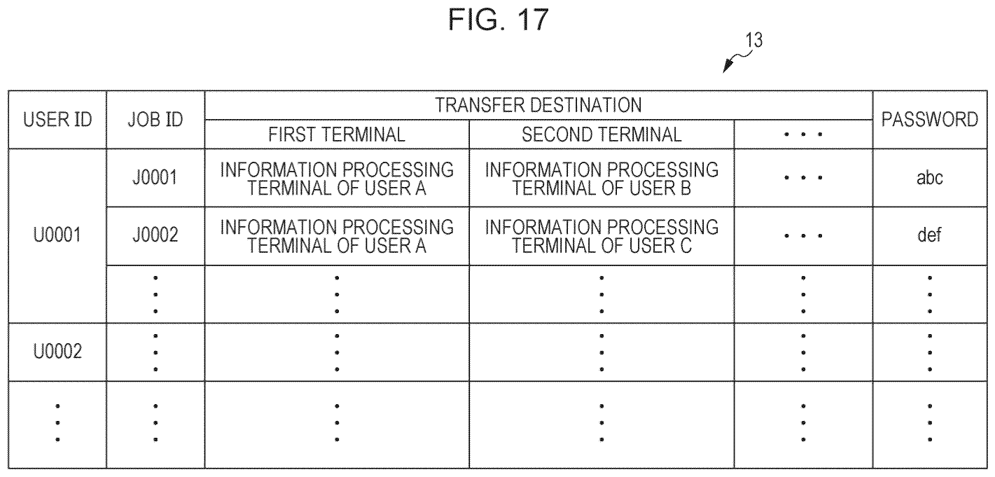

The print setting information database 13B of the exemplary embodiment is described with reference to FIG. 17. FIG. 17 illustrates a structure example of the print setting information database 13B of the exemplary embodiment.

The transfer destination and the verification password are registered on the print setting information database 13B. Referring to FIG. 17, the print setting information database 13B associates a user identification (ID), job ID, transfer destination, and password.

The user ID identifies each user 70 of the information processing system 1 and is thus different from user to user. The job ID identifies each job and is thus different from job to job. The transfer destination indicates that of the corresponding print job. The password is a verification password set for a corresponding print job.

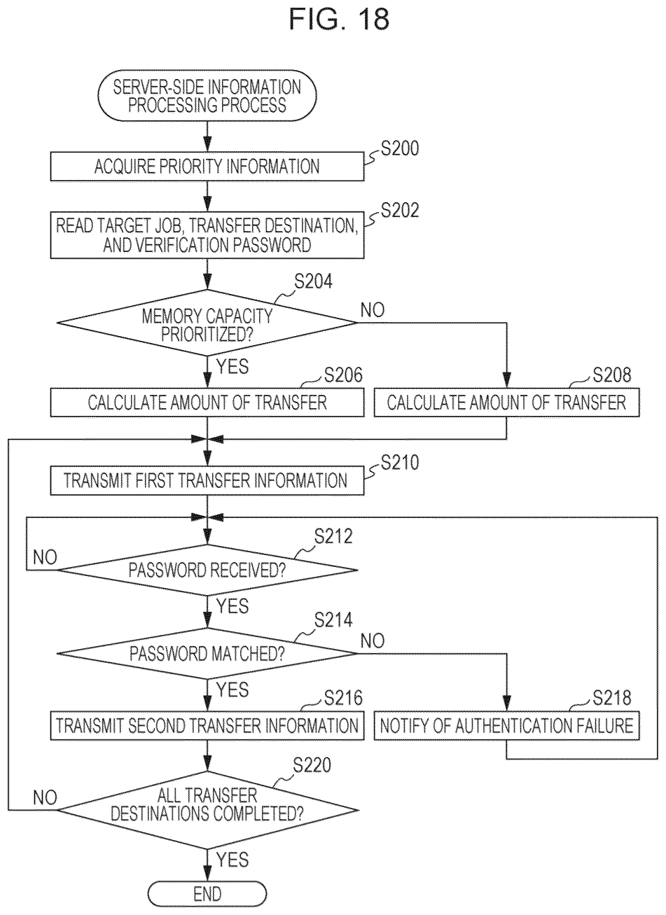

The transfer division process of the information processing system 1 of the exemplary embodiment is described with reference to FIGS. 18 through 20.

The function of the cloud server 10 that performs a server-side information processing process to transfer (spool) the registered print job to the information processing terminal 30 is described with reference to FIG. 18. FIG. 18 is a flowchart illustrating an example of the server-side information processing process according to the exemplary embodiment. When information on a new print job (hereinafter referred to as a “target job”) is registered on the print setting information database 13B and the specific operation is completed, the CPU 11 in the cloud server 10 performs the server-side information processing process illustrated in FIG. 18 by executing the server-side information processing program 13A. For convenience of explanation, priority information indicating which of the capacity priority and the time priority is set is pre-registered through the priority target setting function.

Referring to FIG. 18, the CPU 11 acquires the priority information in step S200. In step S202, the CPU 11 reads the registered target job while also reading a transfer destination and a verification password corresponding to the target job from the print setting information database 13B. In step S204, the CPU 11 determines whether the acquired priority information indicates the setting of the capacity priority. If the yes path is followed in step S204, the CPU 11 proceeds to step S206.

In step S206, the CPU 11 calculates, as an amount of transfer, an amount of data at the percentage applicable to the capacity priority (10% of the target job in the exemplary embodiment) from the amount of data of the target job and then proceeds to step S210.

If the no path is followed in step S204, the CPU 11 determines that the acquired priority information indicates that the time priority is set. The process proceeds to step S208. In step S208, the CPU 11 calculates, as an amount of transfer, an amount of data at the percentage applicable to the time priority (90% of the target job in the exemplary embodiment) from the amount of data of the target job and then proceeds to step S210.

In step S210, the CPU 11 extracts, from the target job, information (hereinafter referred to as “first transfer information”) corresponding to the amount of transfer calculated in the operation in step S206 or S208 and transmits the first transfer information to one of the information processing terminals 30 read as the transfer destinations. According to the exemplary embodiment, the first transfer information includes the attribute information on the target job. This is because the information processing terminal 30 may identify details of the corresponding target job by referencing the attribute information on the received first transfer information.

In response to the reception of the first transfer information, the information processing terminal 30 transmits the verification password entered by the user 70 as described below. In step S212, the CPU 11 waits on standby until the verification password is received from the information processing terminal 30 having transmitted the first transfer information. In step S214, the CPU 11 determines whether the received verification password matches the verification password read in the operation in step S202. If the yes path is followed, the process proceeds to step S216.

In step S216, the CPU 11 transfers, to the corresponding information processing terminal 30, the target job excluding the first transfer information transferred in the operation in step S210 (hereinafter referred to as “second transfer information”) and then proceeds to step S220. On the other hand, if the no path is followed in step S214, the CPU 11 determines that the authentication through the verification passwords has failed and then the process proceeds to step S218.

In step S218, the CPU 11 notifies the corresponding information processing terminal 30 that the authentication through the verification passwords has failed ((hereinafter referred to as “authentication failure notification”) and then returns to step S212. In response to the reception of the authentication failure notification, the corresponding information processing terminal 30 causes the user 70 to enter the verification password again and then transmits the verification password to the cloud server 10. In the information processing system 1 of the exemplary embodiment, the authentication is iterated until the matching of the verification passwords is successfully completed. The disclosure is not limited to this setting. For example, a limit may be set on the number of matching operations.

In step S220, the CPU 11 determines whether the target job has been transferred to all the read transfer destinations. If the no path is followed, the process returns to step S210. If the yes path is followed, the CPU 11 ends the server-side information processing process.

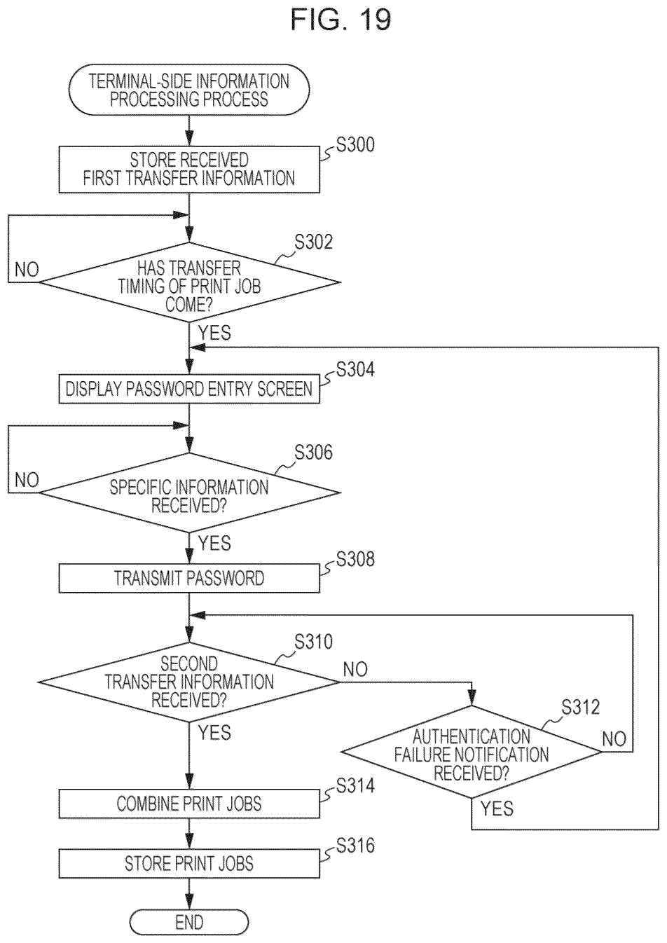

The function of the information processing terminal 30 that performs a terminal-side information processing process that spools the print job is described with reference to FIG. 19. FIG. 19 is a flowchart illustrating an example of the terminal-side information processing process according to the exemplary embodiment. The CPU 31 in the information processing terminal 30 performs the terminal-side information processing process by performing a terminal-side information processing program 33A when the first transfer information is received from the cloud server 10.

Referring to FIG. 19, the CPU 31 stores the received first transfer information on the storage 33 in step S300 and then the CPU 31 waits on standby in step S302 until a print timing when the image forming apparatus 50 performs printing in response to the print job including the first transfer information. According to the exemplary embodiment, the print timing is a timing when the user 70 provides instruction information indicating a print instruction for printing in accordance with the print job including the first transfer information. The disclosure is not limited to this setting. For example, the print timing may be a timing when the position detected by the position detector 39 in the information processing terminal 30 falls within a predetermined distance (for example, 2 m) from any pre-registered image forming apparatus 50.

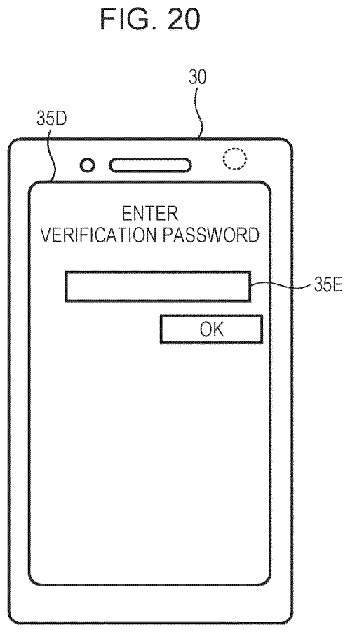

The CPU 31 controls the display 35 in step S304 to display a password entry screen 35D having a predetermined form and waits on standby in step S306 until specific information is entered. FIG. 20 illustrates an example of the password entry screen 35D according to the exemplary embodiment.

Referring to FIG. 20, the password entry screen 35D of the exemplary embodiment displays a message prompting the user 70 to enter the verification password. The password entry screen 35D also displays a password entry box 35E that receives the verification password.

When the password entry screen 35D in FIG. 20 is displayed, the user 70 selects the OK button after entering the verification password in the password entry box 35E using the input unit 34. When the OK button is selected by the user 70, the yes path is followed in step S306. In step S308, the CPU 31 transmits the verification password entered by the user 70 to the cloud server 10.

Upon receiving the verification password, the cloud server 10 performs matching in accordance with the verification passwords. If the matching is successful, the cloud server 10 transmits the second transfer information. If the matching fails, the cloud server 10 transmits the authentication failure notification.

In step S310, the CPU 31 determines whether the second transfer information has been received from the cloud server 10. If the yes path is followed, the process proceeds to step S314. If the no path is followed, the process proceeds to step S312. In step S312, the CPU 31 determines whether the authentication failure notification has been received from the cloud server 10. If the no path is followed, the process returns to step S310. If the yes path is followed, the process returns to step S304.

In step S314, the CPU 31 generates the print job by combining the received first and second transfer information and in step S316, the CPU 31 ends the terminal-side information processing process after storing the generated print job on the storage 33.

### Second Exemplary Embodiment

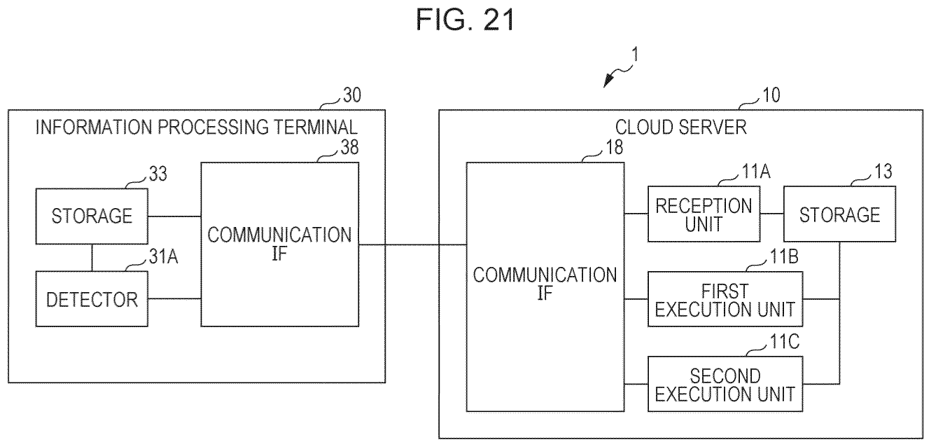

In a second exemplary embodiment, the amount of data of the first transfer information is dynamically determined in accordance with the remaining memory capacity of the information processing terminal 30. The whole configuration and basic processes of the information processing system 1 of the second exemplary embodiment are substantially identical to those of the first exemplary embodiment (see FIGS. 1 through 15). The functional configuration of the information processing system 1 of the second exemplary embodiment is described with reference to FIG. 21. FIG. 21 is a functional block diagram illustrating the information processing system 1 according to the second exemplary embodiment. In FIG. 21, elements identical to those in FIG. 16 are designated with the same reference numerals and the discussion thereof is omitted herein.

The information processing system 1 of the second exemplary embodiment in FIG. 21 is different from the information processing system 1 of the first exemplary embodiment in that the information processing terminal 30 in the information processing system 1 of the second exemplary embodiment includes a deletion unit 31A.

The deletion unit 31A in the information processing terminal 30 of the second exemplary embodiment detects the remaining memory capacity of the storage 33 in the information processing terminal 30. The first execution unit 11B in the cloud server 10 of the second exemplary embodiment results in a higher percentage as the remaining memory capacity detected by the deletion unit 31A is higher. The CPU 31 in the information processing terminal 30 operates as the deletion unit 31A by executing the terminal-side information processing program 33A.

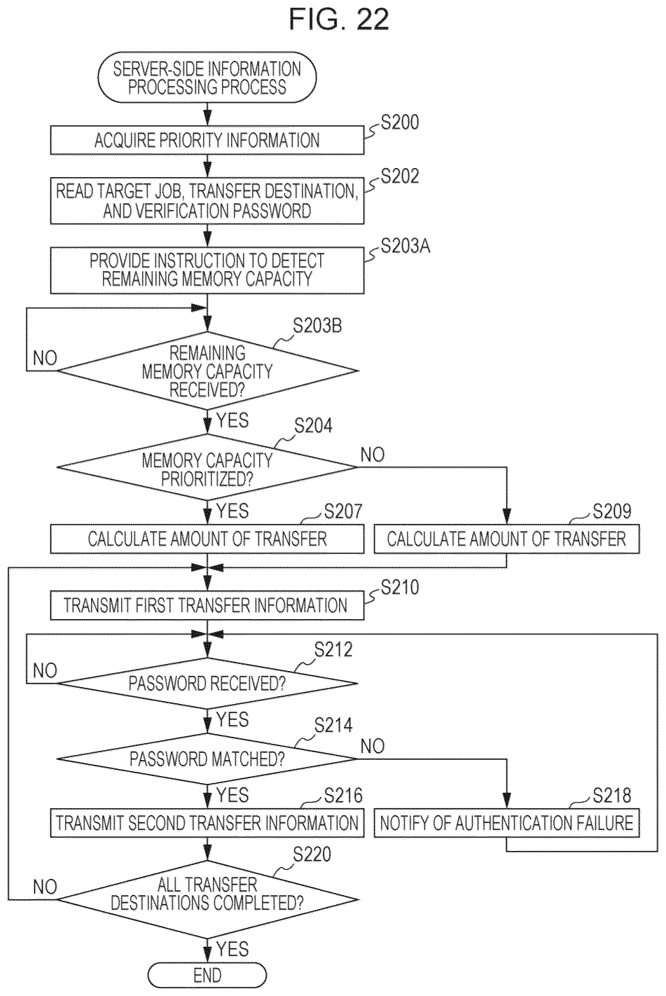

The function of the cloud server 10 in the server-side information processing process of transferring (spooling) the registered print job to the information processing terminal 30 is described with reference to FIG. 22. FIG. 22 is a flowchart illustrating an example of the server-side information processing process according to the second exemplary embodiment. In FIG. 22, step numbers identical in function to those in FIG. 18 are designated with the same step numbers and the discussion thereof is omitted herein.

In step S203A, the CPU 11 transmits, to the information processing terminal 30 as a target, detection instruction information indicating a detection instruction to detect the remaining memory capacity. Upon receiving the detection instruction information, the information processing terminal 30 detects the remaining memory capacity of the storage 33 of the information processing terminal 30 and transmits the remaining memory capacity to the cloud server 10.

In step S203B, the CPU 11 waits on standby until the remaining memory capacity has been received from the target information processing terminal 30.

In step S207, the CPU 11 calculates the amount of transfer from the amount of data of the target job in a manner such that the amount of transfer falls within a range of the percentage applicable to the capacity priority (within a range equal to or higher than 10% and lower than 50% of the target job in the second exemplary embodiment) and is higher as the remaining memory capacity is higher. The process proceeds to step S210. According to the second exemplary embodiment, the amount of transfer is obtained by multiplying the amount of data of the target job by a value that is obtained by multiplying 50% by the percentage of the remaining memory capacity having a maximum value of 1. The disclosure is not limited to this setting.

In step S209, the CPU 11 calculates the amount of transfer from the amount of data of the target job in a manner such that the amount of transfer falls within a range of the percentage applicable to the time priority (within a range equal to or higher than 50% and lower than 90% of the target job in the second exemplary embodiment) and is higher as the remaining memory capacity is higher. The process proceeds to step S210. According to the second exemplary embodiment, the amount of transfer is obtained by multiplying the amount of data of the target job by a value that is obtained by multiplying 90% by the percentage of the remaining memory capacity having a maximum value of 1. The disclosure is not limited to this setting.

In the server-side information processing process, the amount of data of the first transfer information may be appropriately set in accordance with the capacity priority or the time priority set in the priority target setting function and the remaining memory capacity of the information processing terminal 30 at the spool destination.

According to the second exemplary embodiment, the amount of data of the first transfer information is determined in view of the remaining memory capacity with the priority target setting function applied. The disclosure is not limited to this setting. For example, the amount of data of the first transfer information may be determined in view of only the remaining memory capacity with the priority target setting function not applied.

According to each of the exemplary embodiments, the cloud server 10 performs the matching of the verification passwords. The disclosure is not limited to this setting. For example, the matching of the verification passwords may be performed by the information processing terminal 30.

According to each of the exemplary embodiments, the print setting information database 13B is registered on the cloud server 10. The disclosure is not limited to this setting. For example, the print setting information database 13B may be registered on another apparatus that is accessible to the client computer 20, information processing terminal 30, image forming apparatus 50 or cloud server 10.

According to each of the exemplary embodiments, the regular information processing terminal 30 to which the second transfer information is to be transferred is identified using the verification password. The disclosure is not limited to this setting. For example, the regular information processing terminal 30 to which the second transfer information is to be transferred may be identified by using authentication techniques including authentication using login information on the user 70 or face recognition, instead of using the verification password.

According to each of the exemplary embodiments, the attribute information is included in the first transfer information. The disclosure is not limited to this setting. For example, the first transfer information may not include the attribute information but include only part of the print information.

According to each of the exemplary embodiments, the number of divisions of the print job is two in the transfer division process. The disclosure is not limited to this setting. For example, three or more divisions may be applied as the number of divisions of the print job in the transfer division process.

The exemplary embodiments have been described. The scope of the disclosure is not limited to the scope of the described exemplary embodiments. A variety of modifications and variations may be possible in the exemplary embodiments without departing from the scope of the disclosure. The exemplary embodiments thus with such modifications and changes implemented therewithin may still fall within the scope of the disclosure.

The exemplary embodiments are not intended to limit the scope of the disclosure defined by the claims. All features described with reference to the exemplary embodiments are not necessarily used to form the disclosure. The exemplary embodiments include a variety of phases of the disclosure and a combination of disclosed elements may form a variety of disclosures. If a subset of elements is deleted from all the elements illustrated with reference to the embodiments, a configuration with the subset deleted may form a disclosure as long as the configuration has an effect.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The “system” typically includes multiple apparatuses in the exemplary embodiments but, alternatively, only a single apparatus may form the system.

According to the exemplary embodiments, each process is implemented by a software configuration when a computer executes the corresponding program. The disclosure is not limited to this method. For example, each process may be implemented by a hardware configuration or a combination of the software configuration and the hardware configuration.

The configurations of the cloud server 10, client computer 20, information processing terminal 30, and image forming apparatus 50 have been described for exemplary purposes only and an element may be deleted therefrom or a new element may be added thereto without departing from the scope of the disclosure.

The flow processes described with reference to the exemplary embodiments have been described for exemplary purposes only and a step may be deleted from the processes, a new step may be added to the processes, or the order of operations of the processes may be changed without departing from the scope of the disclosure.

According to each of the exemplary embodiments, the user of the information processing terminal 30 enters the password each time the second transfer information is transferred to the cloud server 10. The disclosure is not limited to this setting. For example, the password may be beforehand registered on the information processing terminal 30 and then used without entering the password each time. In such a case, the second transfer information may be transferred at a variety of timings.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
one or more processors configured to:
   accept that a user registers print information serving as a print target and an information processing terminal serving as a transfer destination of the print information;
   in transferring the registered print information to the registered information processing terminal, perform a first transfer operation that transfers a first portion of the print information to the information processing terminal; and
   if the information processing terminal serving as the transfer destination is verified as being an information processing terminal of a regular user after the first transfer operation, perform a second transfer operation that transfers a second portion of the print information to the information processing terminal.
      (((2)))

In the information processing system according to (((1))), the first portion of the print information is a predetermined percentage of the print information.

(((3)))

In the information processing system according to (((2))), the processor is configured to receive the predetermined percentage.

(((4)))

In the information processing system according to (((2))), the processor is configured to:
detect a remaining memory capacity of the information processing terminal; and
set the predetermined percentage to a higher value as the detected remaining memory capacity is higher.
   (((5)))

In the information processing system according to one of (((1))) through (((4))), the verifying is performed using a password.

(((6)))

In the information processing system according to (((5))), the password is pre-registered by the user.

(((7)))

In the information processing system according to one of (((1))) through (((6))), the information processing terminal is a mobile terminal.

What is claimed is:

1. An information processing system comprising:
one or more processors configured to:
accept that a user registers print information serving as a print target and an information processing terminal serving as a transfer destination of the print information;
in transferring the registered print information to the registered information processing terminal, perform a first transfer operation that transfers a first portion of the print information to the information processing terminal; and
if the information processing terminal serving as the transfer destination is verified as being an information processing terminal of a regular user after the first transfer operation, perform a second transfer operation that transfers a second portion of the print information to the information processing terminal.

2. The information processing system according to claim 1, wherein the first portion of the print information is a predetermined percentage of the print information.

3. The information processing system according to claim 2, wherein the processor is configured to receive the predetermined percentage.

4. The information processing system according to claim 2, wherein the processor is configured to:
detect a remaining memory capacity of the information processing terminal; and
set the predetermined percentage to a higher value as the detected remaining memory capacity is higher.

5. The information processing system according to claim 1, wherein the verifying is performed using a password.

6. The information processing system according to claim 2, wherein the verifying is performed using a password.

7. The information processing system according to claim 5, wherein the password is pre-registered by the user.

8. The information processing system according to claim 6, wherein the password is pre-registered by the user.

9. The information processing system according to claim 1, wherein the information processing terminal is a mobile terminal.

10. The information processing system according to claim 2, wherein the information processing terminal is a mobile terminal.

11. A non-transitory computer readable medium storing a program causing a computer to execute a process for processing information, the process comprising:
accepting that a user registers print information serving as a print target and an information processing terminal serving as a transfer destination of the print information;
in transferring the registered print information to the registered information processing terminal, performing a first transfer operation that transfers a first portion of the print information to the information processing terminal; and
if the information processing terminal serving as the transfer destination is verified as being an information processing terminal of a regular user after the first transfer operation, performing a second transfer operation that transfers a second portion of the print information to the information processing terminal.

12. An information processing method comprising:
accepting that a user registers print information serving as a print target and an information processing terminal serving as a transfer destination of the print information;
in transferring the registered print information to the registered information processing terminal, performing a first transfer operation that transfers a first portion of the print information to the information processing terminal; and
if the information processing terminal serving as the transfer destination is verified as being an information processing terminal of a regular user after the first transfer operation, performing a second transfer operation that transfers a second portion of the print information to the information processing terminal.
